(19) United States
(12) Patent Application Publication
(10) Pub. No.: US 2013/0241187 A1
(43) Pub. Date: Sep. 19, 2013

(54) SENSOR

(71) Applicants: Peter Baumgartner, Gunzburg (DE); Hermann Hasse, Lonsee (DE); Oswald Lustig, Asselfingen (DE)

(72) Inventors: Peter Baumgartner, Gunzburg (DE); Hermann Hasse, Lonsee (DE); Oswald Lustig, Asselfingen (DE)

(73) Assignee: TAKATA AG

(21) Appl. No.: 13/989,553

(22) PCT Filed: Dec. 7, 2011
(86) PCT No.: PCT/DE2011/050054

§ 371 Date: May 24, 2013

(30) Foreign Application Priority Data
Dec. 22, 2010 (DE) 102010063903.6

(51) Int. Cl. B60R 22/48

(52) U.S. Cl. CPC B60R 22/48
USPC 280/806

(57) ABSTRACT

The invention relates to a sensor (10), in particular for triggering a vehicle occupant restraint system, comprising an inertia body (20) which has an oscillating bearing (23) permitting an oscillating movement and, in the event of an acceleration, can be set by inertia into an oscillating movement, and a triggering lever (40) which interacts with the inertia body and is deflected when a predetermined amplitude of oscillation is exceeded.

The invention relates to a sensor, in particular for triggering a vehicle occupant restraint system, for example for triggering a locking mechanism of a belt retractor.

A sensor of this type is known, for example, from German laid-open application DE 10 2004 032 190 A1. This previously known sensor has a lower rolling surface which is defined by a track which runs in a curved manner, extends convexly with respect to the inertia body and is designed without a step. The inertia body can execute a translatory rolling movement on the lower rolling surface.

The invention is based on the object of specifying a sensor in which production of noise is avoided or is at least kept as small as possible.

This object is achieved according to the invention by a sensor with the features according to patent claim 1. Advantageous refinements of the sensor according to the invention are specified in dependent claims.

Accordingly, the invention provides a sensor with an inertia body which has an oscillating bearing permitting an oscillating movement and, in the event of an acceleration, can be set by inertia into an oscillating movement, and a triggering lever which interacts with the inertia body and is deflected when a predetermined amplitude of oscillation is exceeded.

A substantial advantage of the sensor according to the invention is considered that of avoiding annoying rolling noises therein. This is because, in contrast to the previously known sensor described at the beginning, the sensor according to the invention uses an oscillating movement rather than a rolling movement. Rolling noises are therefore avoided.

It is considered advantageous if the sensor has a holding element, wherein a first section of the holding element is guided through the oscillating bearing of the inertia body and holds the inertia body pivotably, and a second section of the holding element is guided through a pivot bearing of the triggering lever and holds the triggering lever pivotably. In this refinement, an independent and self-supporting oscillating unit which comprises the holding element, the inertia body and the triggering lever is formed by a single additional component, namely the holding element.

The first and the second sections preferably extend parallel, and therefore the pivot axes of the inertia body and those of the triggering lever are preferably also parallel.

The first section is preferably designed in such a manner that the inertia body can be pivoted out in all directions. For this purpose, the oscillating bearing of the inertia body and/or that section of the inertia body which is indirectly or directly adjacent to the oscillating bearing can have, for example, conically converging side walls.

Particularly preferably, the holding element has a third section which enables fitting of the oscillating unit formed by the holding element, the inertia body and the triggering lever, in particular to or in a housing or to an external vehicle-side support.

The third section of the holding element preferably extends perpendicularly to the first and/or to the second section of the holding element.

With regard to a high degree of stability and low degree of friction in the oscillating bearing of the inertia body and in the pivot bearing of the triggering lever, it is considered advantageous if the holding element is formed by a multiply bent, single-part rod element, and the first, second and third sections of the holding element are sections of said single-part rod element. The rod element can be formed by a multiply bent, single-part metal wire, preferably made of spring steel. Alternatively, the rod element can be composed of plastic or of a metal and plastic composition, i.e. partially of plastic and partially of metal.

The same applies to the oscillating bearing of the inertia body and the pivot bearing of the triggering lever: said bearings are also preferably composed of metal, plastic or a metal and plastic composition.

If the sensor has a frame or a housing, it is considered advantageous if the third section of the holding element is hooked into the frame or the housing of the sensor and thereby fixes the position of the oscillating unit formed by the holding element, the inertia body and the triggering lever relative to the frame or relative to the housing.

It is also considered advantageous if the inertia body has an upper oscillating section and a lower oscillating section, wherein the upper and the lower oscillating sections are separated from each other by the oscillating bearing. The lower oscillating section is preferably composed of metal, for example iron.

The end section of the upper oscillating section may be, for example, plate-shaped or in the shape of a point. In the case of a plate-shaped configuration, a flat, round or conical plate shape is considered advantageous.

The shape of the triggering lever is preferably matched to the shape of the upper oscillating section. If the upper oscillating section is in the shape of a point, a dish-shaped triggering lever is considered advantageous, wherein the point of the upper oscillating section is preferably guided in a dish section of the dish-shaped triggering lever.

If the end section of the upper oscillating section is plate-shaped, a triggering lever with a cup-shaped section is considered advantageous, wherein the plate-shaped end section of the upper oscillating section is preferably guided in the cup-shaped section of the triggering lever.

Furthermore, it is considered advantageous if the mass of the upper oscillating section is smaller than the mass of the lower oscillating section. The mass of the lower oscillating section is preferably at least ten times larger than that of the upper oscillating section.

The arrangement of the oscillating bearing, the lever length of the upper and lower oscillating sections and the respective mass of the upper and lower oscillating sections determine the oscillating behavior of the inertia body and the sensitivity of the sensor. The parameters mentioned can be adapted to one another depending on the desired sensitivity of the sensor.

In order to avoid unnecessary triggering of the sensor in the event of small vehicle accelerations, it is considered advantageous if the triggering lever has a supporting section which, in the oscillation-free rest position of the inertia body, rests on the upper oscillating section and, by means of gravitational force, opposes an oscillating movement of the inertia body. In this refinement, the supporting section can be caused by gravitational force to press with the mass thereof against the upper oscillating section and can avoid oscillating in the event of only small vehicle accelerations.

Alternatively, it is considered advantageous if the triggering lever has an interaction section which, in the oscillation-free rest position of the inertia body, is spaced apart from the upper oscillating section and is brought into contact with the upper oscillating section only in the event of an oscillating movement, the amplitude of which exceeds a predetermined threshold.

It is also considered advantageous if the oscillating bearing is formed by a ball and socket joint, since ball and socket joints enable deflection of the inertia body and oscillation in all directions.

The invention also relates to an arrangement with a sensor, as described above, and with a vehicle, wherein the holding element is hooked into a vehicle-side support.

The invention furthermore relates to a belt retractor with a locking mechanism which is provided with a sensor of the described type. With regard to the advantages of the belt retractor according to the invention, reference is made to the abovementioned advantages of the sensor according to the invention. The belt retractor will produce less noise than previously known belt retractors, since the sensor contained therein operates quietly.

The invention is explained in more detail below with reference to exemplary embodiments, in which, by way of example

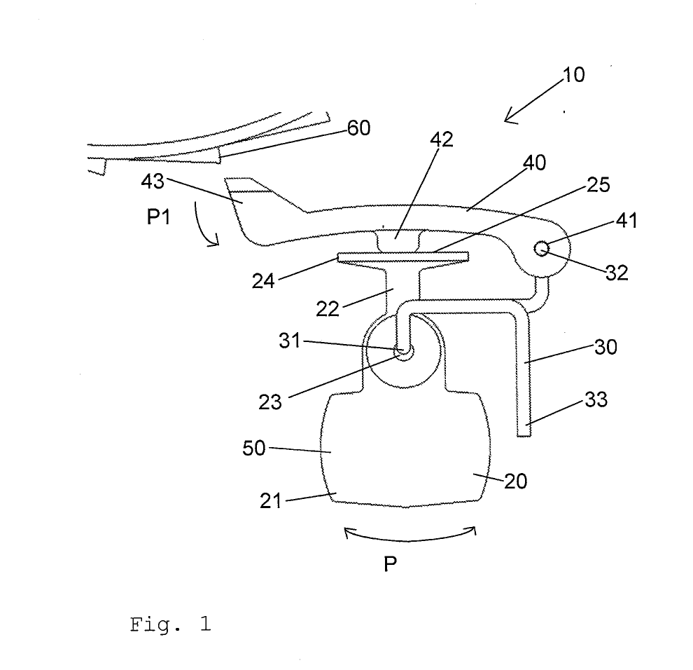

FIG. 1 shows a first exemplary embodiment of a sensor according to the invention in the rest position thereof,

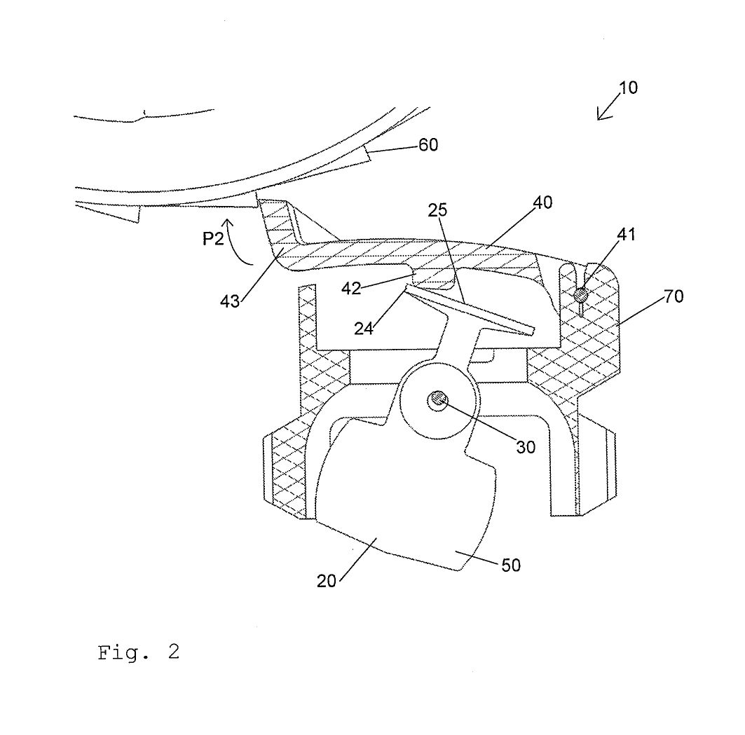

FIG. 2 shows the sensor according to FIG. 1 with a deflected inertia body,

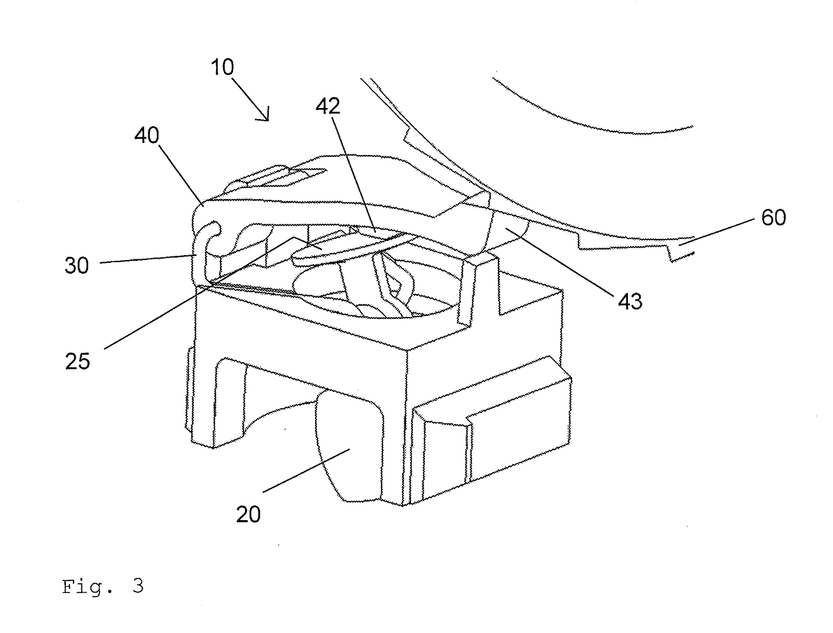

FIG. 3 shows the sensor according to FIGS. 1 and 2 in a three-dimensional view,

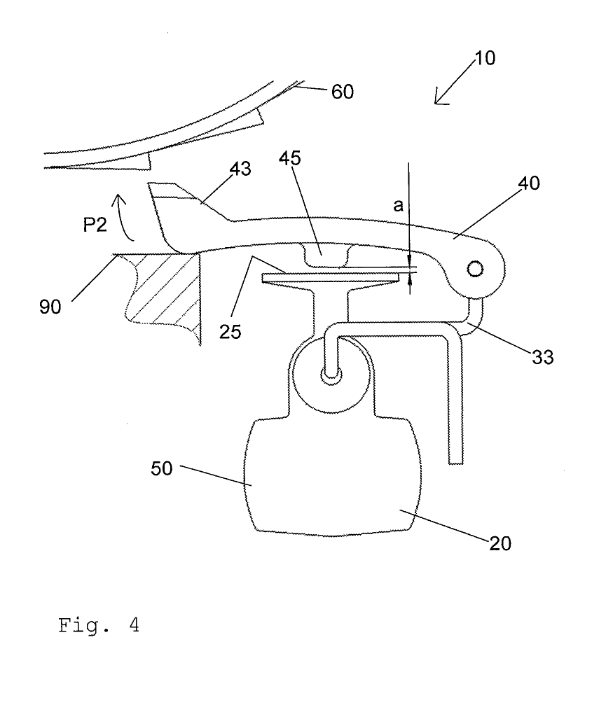

FIG. 4 shows a second exemplary embodiment of a sensor according to the invention in the rest position thereof,

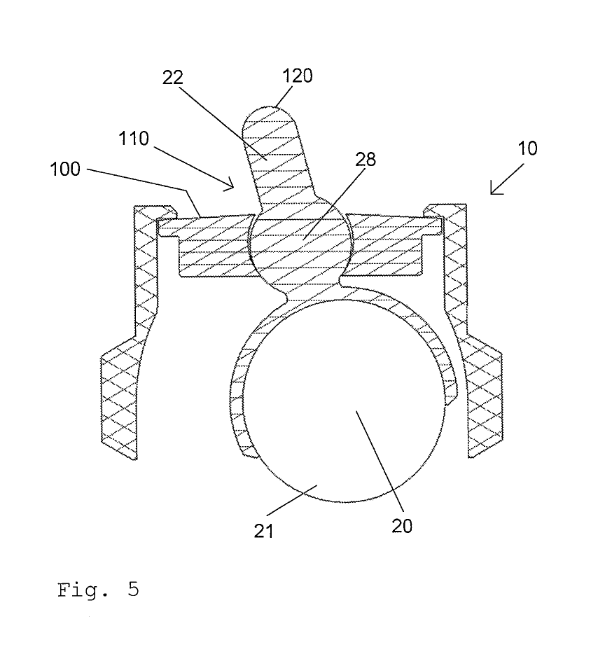

FIG. 5 shows an exemplary embodiment of a sensor according to the invention with a ball element,

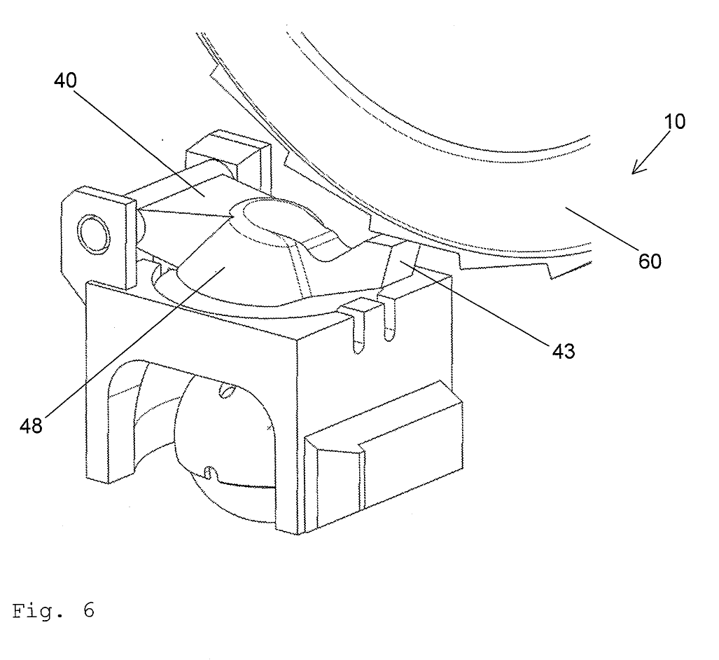

FIG. 6 shows the sensor according to FIG. 5 in a three-dimensional illustration,

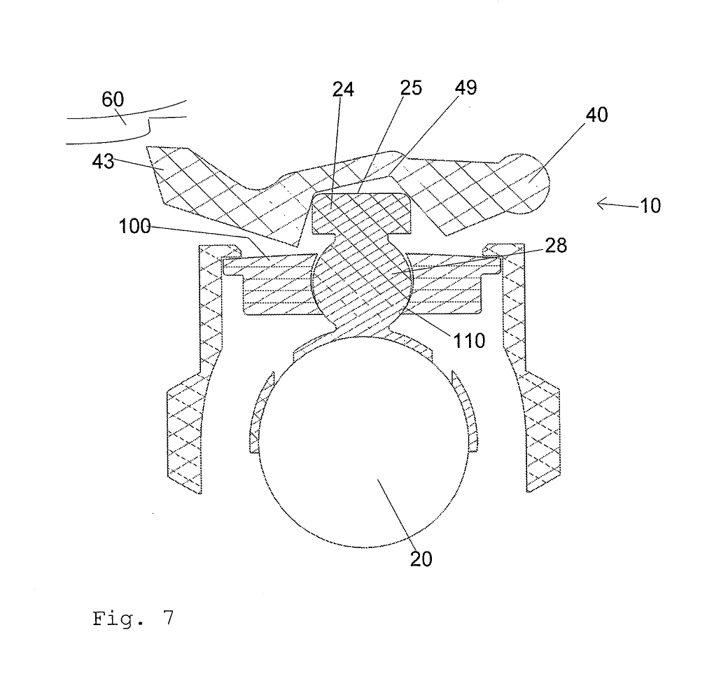

FIG. 7 shows a further exemplary embodiment of a sensor according to the invention with a ball and socket joint,

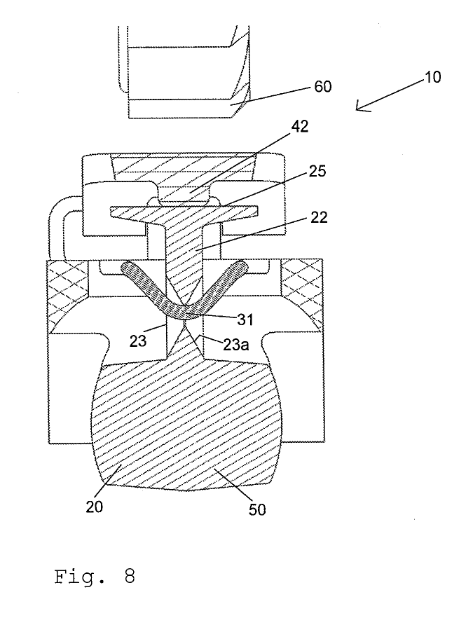

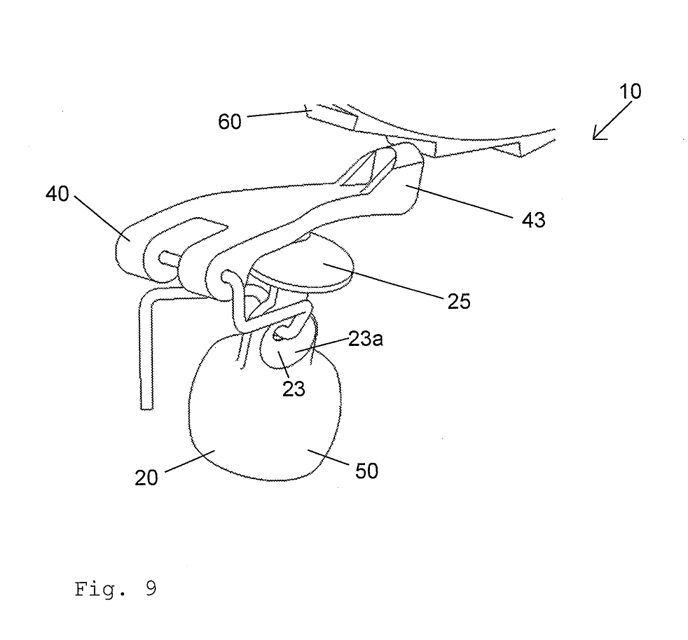

FIGS. 8-9 show an example in more detail of an oscillating bearing for the first exemplary embodiment according to FIGS. 1 to 3 and the second exemplary embodiment according to FIG. 4, and

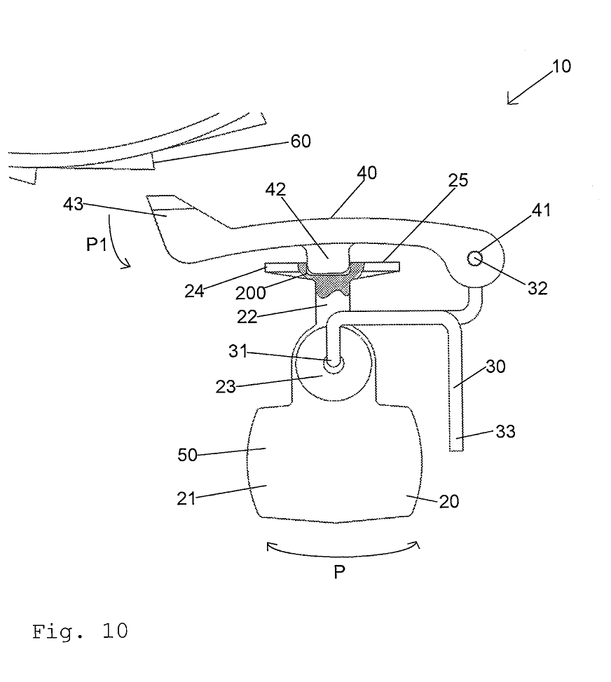

FIG. 10 shows the possibility of a “noiseless position” of the inertia body by means of a form fit.

For the sake of clarity, the same reference numbers are always used for identical or comparable components in the figures.

FIG. 1 shows a sensor 10 which comprises an inertia body 20. The inertia body 20 has a lower oscillating section 21 and an upper oscillating section 22. An oscillating bearing 23 is located between the two oscillating sections 21 and 22 of the inertia body 20.

It can be seen in FIG. 1 that the end section 24 of the upper oscillating section 22 is configured in a plate-shaped manner and forms an upper, flat or planar supporting surface 25.

FIG. 1 furthermore shows a holding element 30 which is formed by a multiply bent, single-part rod element. A first section 31 of the holding element 30 is guided through the oscillating bearing 23 of the inertia body 20 and, for said oscillating bearing 23, forms a first shaft about which the inertia body 20 can pivot.

A second section 32 of the holding element 30 is guided through a pivot bearing of a triggering lever 40 where it forms a second shaft, namely a pivot shaft for the triggering lever 40. The triggering lever 40 can pivot about said second shaft. The pivot bearing of the triggering lever 40 is identified in FIG. 1 by the reference number 41.

The inertia body 20 and the triggering lever 40 are connected to each other by the holding element 30, and therefore an independent and self-supporting oscillating unit 50 is formed by the three components, namely the inertia body 20, the holding element 30 and the triggering lever 40.

It can also be seen in FIG. 1 that the first section 31—or the first shaft—and the second section 32—or the second shaft—of the holding element 30 are preferably arranged parallel, and therefore the pivot axis of the inertia body 20 and that of the triggering lever 40 are also parallel. By means of such a parallel arrangement, a particularly compact construction of the oscillating unit 50 can be achieved.

The first section 31 of the holding element 30 is preferably arranged in such a manner that the inertia body 20 can execute an oscillating movement in the longitudinal direction of the vehicle. An oscillating movement in the longitudinal direction of the vehicle is identified by a double arrow and the reference symbol P in FIG. 1.

It can furthermore be seen in FIG. 1 that the triggering lever 40 is provided with a supporting section 42 by which the triggering lever 40 rests on the upper supporting surface 25 of the end section 24 of the inertia body 20. The resting of the supporting section 42 is brought about by gravitation, since the triggering lever 40, because of the gravitational force thereof, will pivot downward about the pivot bearing 41 thereof in the pivoting direction P1.

In the illustration according to FIG. 1, the inertia body 20 is in a rest position, i.e. does not oscillate. The supporting section 42 therefore rests silently on the upper supporting surface 25, and therefore a locking section 43 of the triggering lever 40 is not in engagement with a locking base 60. The locking base 60 is part of a locking mechanism (not illustrated in more detail) of a belt retractor (likewise not illustrated in more detail).

The effect achieved on account of the dead weight of the triggering lever 40 and on account of the supporting section 42 of the triggering lever 40 pressing onto the upper supporting surface 25 of the inertia body 20 is that an oscillating movement of the inertia body 20 is suppressed, or at least made difficult, at smaller changes in acceleration of the vehicle. An undesirable production of noise is therefore prevented in the event of only small changes in acceleration of the vehicle. If, by contrast, a pronounced change in the acceleration or a jerky movement of the vehicle occurs, the triggering lever 40 will no longer be able to prevent the inertia body 20 from oscillating, and therefore the triggering lever 40 will be deflected and the locking section 43 will engage in the locking base 60.

In addition, a silent position of the inertia body 20 can also be brought about by a form fit, as shown by way of example in FIG. 10. FIG. 10 shows a depression 200 in the inertia body 20, in which depression the supporting section 42 of the triggering lever 40 can engage with a form fit.

Furthermore, a third section 33 of the holding element 30 can be seen in FIG. 1. Said third section 33 of the holding element 30 serves to fasten the holding element 30 and therefore the entire oscillating unit 50 to a support or a housing. Such a fastening is explained in more detail in conjunction with FIGS. 2 and 3.

FIG. 2 shows the oscillating unit 50 according to FIG. 1 after the third section 33 (cf. FIG. 1) has been pushed into an elongate holding hole in a housing 70 of the sensor 10. The oscillating unit 50 is therefore hooked in the housing 70 by the third section of the holding element 30, and the position of the oscillating unit 50 relative to the housing 70 is defined.

The third section of the holding element 30 is preferably oriented perpendicularly to the first section 31 and perpendicularly to the second section 32 of the holding element 30 in order to achieve as compact a construction of the sensor 10 as possible.

Furthermore, it can be seen in FIG. 2 that the inertia body 20 is in an oscillating movement and the upper supporting surface 25 of the end section 24 of the inertia body 20 has raised the supporting section 42 of the triggering lever 40, as a result of which the triggering lever 40 has been pivoted about the pivot bearing 41 thereof. By pivoting of the triggering lever 40 upward in the arrow direction P2, the locking section 43 enters into engagement with the locking base 60 such that the locking base 60 is locked, rotation of the locking base is prevented and therefore, for example, extension of a belt strap of a seat belt is stopped.

FIG. 3 shows the sensor 10 according to FIGS. 1 and 2 once again in a three-dimensional view. It is seen that the upper supporting surface 25 of the inertia body 20 has pivoted the supporting section 42 of the triggering lever 40 upward such that the locking section 43 can enter into engagement with the locking base 60.

FIG. 4 shows a second exemplary embodiment of a sensor 10. An inertia body 20, a holding element 30 and a triggering lever 40, which together form an oscillating unit 50, are seen. In the exemplary embodiment according to FIG. 4, the triggering lever 40 does not have a supporting section which would rest on the upper supporting surface 25 of the inertia body 20 in the rest state. Instead, an interaction section 45 is provided, said interaction section entering into contact with the upper supporting surface 25 only in the event of an oscillating movement of the inertia body 20. In order to achieve a spatial separation and a distance “a” between the triggering lever 40 and between the interaction section 45 and the upper supporting surface 25, the sensor 10 is provided with a stop 90 on which the locking section 43 of the triggering lever 40 rests in the rest state. In the rest state, i.e. if there is no oscillating movement of the inertia body 20, the triggering lever 40 and the inertia body 20 are therefore separated from each other such that there is neither friction between the triggering lever 40 and inertia body 20 nor production of noise.

If, on account of an abrupt change in the acceleration of the vehicle, an oscillating movement of the inertia body 20 then occurs, at a sufficient amplitude of the oscillating movement the upper supporting surface 25 of the inertia body 20 will strike against the interaction section 45 of the triggering lever 40 and pivot the triggering lever upward in the arrow direction P2 such that the locking section 43 of the triggering lever 40 can engage in the locking base 60.

FIGS. 8 and 9 show an exemplary embodiment of the oscillating bearing 23 of the sensor 10 according to FIGS. 1 to 3 and of the oscillating bearing of the sensor 10 according to FIG. 4 in more detail. It can be seen that the inertia body 20 can pivot in all directions. In the exemplary embodiment according to FIGS. 8 and 9, the oscillating bearing 23 has side walls 23a converging conically.

FIG. 5 shows a third exemplary embodiment of a sensor 10. The sensor 10 has an inertia body 20 with a lower oscillating section 21 and an upper oscillating section 22. The two oscillating sections 21 and 22 are separated from each other by a spherical section 28 of the inertia body 20. The spherical section 28 together with an associated bearing 100 forms a ball and socket joint 110 which supports the inertia body 20 pivotably.

It is furthermore seen in FIG. 5 that the upper oscillating section 22 is in the shape of a point and has an upper point 120. In the event of an oscillating movement of the inertia body 20, the upper point 120 will correspondingly oscillate at the same time.

FIG. 6 shows the sensor according to FIG. 5 in a three-dimensional illustration. It is seen that the sensor 10 has a dish-shaped triggering lever 40 which is provided with a dish section 48. The shape of the dish section 48 is matched to the shape of the point 120 of the inertia body 20 such that, in the event of an oscillating movement of the inertia body 20, the dish-shaped triggering lever 40 can be deflected and the locking section 43 can be brought into engagement with the locking base 60.

FIG. 7 shows a fourth exemplary embodiment of a sensor 10. Also in this exemplary embodiment, the inertia body 20 is provided with a spherical section 28 which is held by a bearing 100. The end section 24 of the upper oscillating section is configured in a plate-shaped manner. The shape of the triggering lever 40 is matched to the plate shape of the end section 24: the triggering lever 40 thus has a cup-shaped section 49 in which the plate-shaped end section 24 engages.

If, in the event of a change in the acceleration of the vehicle, an oscillating movement of the inertia body 20 occurs, the resultant oscillating movement of the plate-shaped end section 24 will lead to a deflection of the triggering lever 40 such that a locking section 43 of the triggering lever 40 can engage in a locking base 60.

It can be seen in FIG. 7 that the cup-shaped section of the triggering lever 40 has an at least approximately planar base surface which, in the rest state of the inertia body 20, is oriented at an angle relative to the upper supporting surface 25 of the inertia body 20.

### LIST OF DESIGNATIONS

10 sensor

20 inertia body

21 lower oscillating section

22 upper oscillating section

23 oscillating bearing

23a side walls

24 end section

25 supporting surface

28 spherical section

30 holding element

31 first section

32 second section

33 third section

40 triggering lever

41 pivot bearing

42 supporting section

43 locking section

45 interaction section

48 dish section

49 cup-shaped section

50 oscillating unit

60 locking base

70 housing

90 stop

100 bearing

110 ball and socket joint

120 point

a distance

P oscillating movement

P1 pivoting direction

P2 arrow direction

1-10. (canceled)

11. A sensor (10), in particular for triggering a vehicle occupant restraint system, comprising
an inertia body (20) which has an oscillating bearing (23) permitting an oscillating movement and, in the event of an acceleration, can be set by inertia into an oscillating movement, and
a triggering lever (40) which interacts with the inertia body and is deflected when a predetermined amplitude of oscillation is exceeded
wherein
the holding element (30) is formed by a multiply bent, single-part rod element,
a first section (31) of a holding element (30) is guided through the oscillating bearing (23) and holds the inertia body (20) pivotably, and
a second section (32) of the holding element (30) is guided through a pivot bearing (41) of the triggering lever (40) and holds the triggering lever (40) pivotably.

12. The sensor as claimed in claim 11, wherein
the holding element has a third section (33) which enables fitting of the oscillating unit (50) formed by the holding element (30), the inertia body (20) and the triggering lever (40), in particular to or in a housing (70) or to an external support.

13. The sensor as claimed in claim 12, wherein
the first, second and third sections of the holding element are sections of said single-part rod element.

14. The sensor as claimed in claim 12, wherein
the sensor has a frame or a housing, and
the third section (33) of the holding element (30) is hooked into the frame or the housing (70) of the sensor and fixes the position of the oscillating unit formed by the holding element, the inertia body and the triggering lever relative to the frame or relative to the housing.

15. The sensor as claimed in claim 11, wherein
the inertia body (20) has an upper oscillating section (22) and a lower oscillating section (21), wherein the upper and the lower oscillating sections are separated from each other by the oscillating bearing (23), and
the triggering lever has a supporting section (42) which, in the oscillation-free rest position of the inertia body, rests on the upper oscillating section (22) and, by means of gravitational force, opposes an oscillating movement of the inertia body.

16. The sensor as claimed in claim 11, wherein
the inertia body has an upper oscillating section (22) and a lower oscillating section (21) which are separated from each other by the oscillating bearing (23), and
the triggering lever has an interaction section (45) which, in the oscillation-free rest position of the inertia body, is spaced apart from the upper oscillating section (22) and is brought into contact with the upper oscillating section only in the event of an oscillating movement of the inertia body.

17. The sensor as claimed in claim 11, wherein
the oscillating bearing (23) is part of a ball and socket joint (110).

18. An arrangement with a sensor as claimed in claim 13 and a vehicle, wherein
the third section of the holding element is hooked into a vehicle-side support.

19. A belt retractor with a locking mechanism and a sensor (10) as claimed in claim 11 for triggering the locking mechanism, wherein the triggering lever (40) forms a locking lever for locking a locking base (60) of the belt retractor or an intermediate lever for indirectly or directly deflecting such a locking lever.
